(19) United States
(12) Patent Application Publication
(10) Pub. No.: US 2011/0310614 A1
(43) Pub. Date: Dec. 22, 2011

(54) LED LIGHT FIXTURE HAVING LED MODULES

(76) Inventor: Lothar E. S. Budike, JR., Villanova, PA (US)

(21) Appl. No.: 12/872,769

(22) Filed: Aug. 31, 2010

Related U.S. Application Data
(60) Provisional application No. 61/239,059, filed on Sep. 1, 2009.

(51) Int. Cl. F21V 29/00

(52) U.S. Cl. 362/294; 362/373

(57) ABSTRACT

The present disclosure generally relates to lighting devices and systems. In some embodiments, a light fixture or luminaire is provided. The light fixture may include a housing and one or more light emitting diode (LED) modules provided in the housing. The LED modules may include a heat sink and a light source array. Light source array can be configured to fit into a cavity formed by the sides of the heat sink and may be disposed at a base portion of heat sink. The light source array may be formed by a single or multiple circuit boards that are connected and include a plurality of LED packages. The LED packages may be stacked. A thyristor may be connected in parallel with the LED packages to circuit board(s) that form the light source array.

### CROSS REFERENCE TO RELATED APPLICATIONS

This application claims priority to U.S. Provisional Patent Application No. 61/239,059, filed Sep. 1, 2009, which claims the benefit of U.S. Design patent application Ser. No. 29/342,765 filed Aug. 31, 2009; U.S. Provisional Patent Application No. 61/071,423 filed Apr. 28, 2008; U.S. patent application Ser. No. 12/453,249, filed May 4, 2009; and U.S. patent application Ser. No. 12/453,069, filed Apr. 27, 2009 the contents of which are hereby incorporated herein by reference for all purposes in their entirety.

### BACKGROUND

1. Field

The present disclosure generally relates to lighting devices and systems. More specifically, the present disclosure relates to light fixtures or luminaires.

2. Discussion of the Related Technology

A building may include one or more lighting systems; heating, ventilation, air conditioning (HVAC) systems; electrical systems, etc. The lighting system may include one or more light fixtures or luminaires. The light fixture may be completed (e.g., a luminaire) with a light source or lamp, a reflector for directing light, an aperture or lens, a housing for alignment and protection, a ballast, and a connection to a power source.

### SUMMARY

The present disclosure generally relates to lighting devices and systems. In some embodiments, a light fixture or luminaire is provided. The light fixture may include a housing and one or more light emitting diode (LED) modules provided in the housing. The LED modules may include a heat sink and a light source array. Light source array can be configured to fit into a cavity formed by the sides of the heat sink and may be disposed at a base portion of heat sink. The light source array may be formed by a single or multiple circuit boards that are connected and include a plurality of LED packages. In an embodiment, the LED packages may be stacked. In another embodiment, a thyristor may be connected in parallel with the LED packages to circuit board(s) that form the light source array.

Advantages and features of the disclosure in part may become apparent in the description that follows and in part may become apparent to those having ordinary skill in the art upon examination of the following or may be learned from practice of the disclosure. The advantages and features of embodiments of the present disclosure may be realized and attained by the structures and processes described in the written description, the claims, and in the appended drawings.

It is to be understood that both the foregoing general description and the following detailed description are exemplary and explanatory and should not be construed as limiting the scope of the claims.

### BRIEF DESCRIPTION OF THE DRAWINGS

The accompanying drawings are included to provide a further understanding of the disclosure, and are incorporated herein and constitute a part of this application. The drawings together with the description serve to explain exemplary embodiments of the present disclosure. Wherever possible, the same reference numbers will be used throughout the drawings to refer to the same or like parts. In the drawings:

FIG. 1 illustrates a light fixture, according to an embodiment of the disclosure;

FIGS. 2A-2B illustrate exemplary arrangements of LED light modules in a light fixture, according to embodiments of the disclosure;

FIGS. 3A-3C illustrate exemplary components which may comprise a LED module, according to an embodiment of the disclosure;

FIG. 4 illustrates an exemplary heat sink which may be employed in the LED module of FIGS. 3A-3C, according to an embodiment of the disclosure;

FIGS. 5A-5B illustrate exemplary views of the heat sink and lens that may be employed in the LED module of FIGS. 3A-B, according to embodiments of the disclosure;

FIGS. 6A-6B illustrate exemplary arrangements of circuit boards capable of receiving LED packages, according to embodiments of the disclosure;

FIG. 7 illustrates a circuit board configuration capable of being employed in LED light modules, according to an embodiment of the disclosure;

FIGS. 8A-8B illustrate exemplary configurations of LED modules in a light fixture, according to embodiments of the disclosure;

FIGS. 9A-9B illustrate exemplary configurations of light source arrays provided in a LED module, according to embodiments of the disclosure;

FIG. 10 illustrates an exemplary heat sink configuration and mounting portions capable of being employed in a light fixture, according to an embodiment of the disclosure;

FIG. 11 illustrates an exemplary panel employed in a light fixture, according to an embodiment of the disclosure;

FIG. 12 illustrates an exemplary configuration of LED modules and lenses provided in a light fixture, according to an embodiment of the disclosure;

FIG. 13-15 illustrate exemplary views and configurations of a LED light fixture and devices for deploying the LED light fixture in a building, according to embodiments of the disclosure;

FIG. 16-21 illustrate exemplary arrangements for connecting light fixtures, according to embodiments of the disclosure;

FIG. 22 illustrates an exemplary block diagram of a lighting system capable of controlling and powering one or more light fixtures, according to an embodiment of the disclosure; and

FIG. 23 illustrates an exemplary control module employed in the system of FIG. 22, according to an embodiment of the disclosure.

### DESCRIPTION OF THE EMBODIMENTS

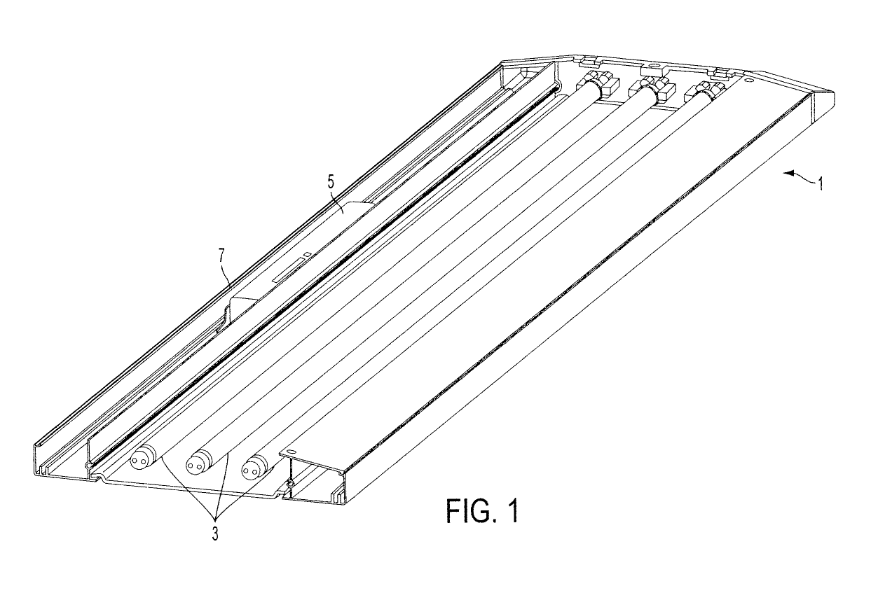

FIG. 1 illustrates a lighting fixture 1 that fixes a plurality of T-5 fluorescent tubes 3 within its fixture. A ballast 5 is fixed to a side channel 7 of the lighting fixture 1 and when powered, the ballast 5 generates a voltage potential that causes a gas mixture within the T-5 fluorescent tubes 3 to ionize and emit ultraviolet light. The ultraviolet light strikes and excites fluorescent materials coated within an inner surface of the tubes, which convert the ultraviolet light into visible light. Such a lighting fixture is used to light up commercial or residential areas.

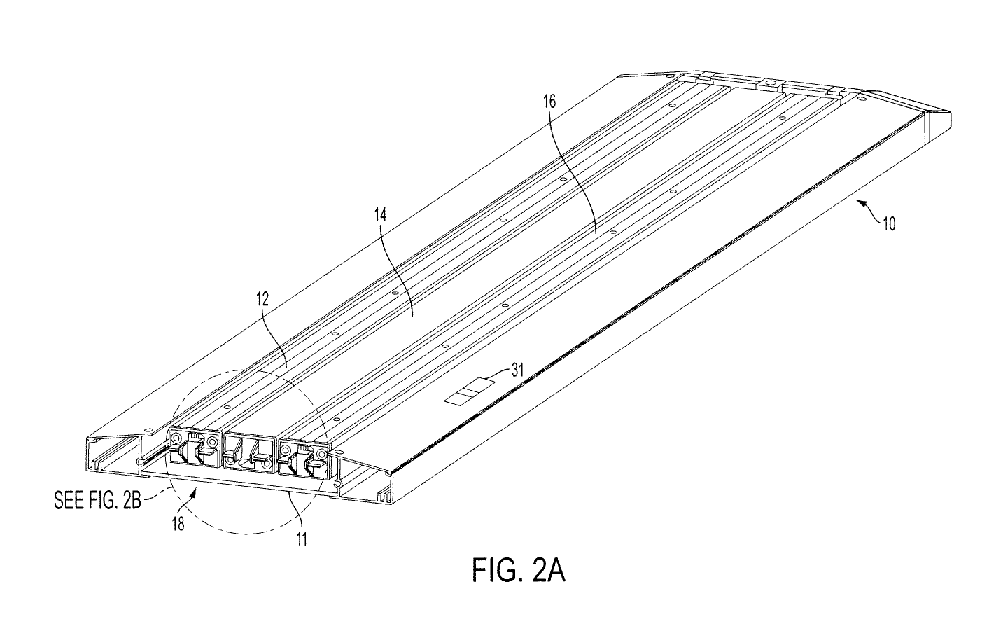

With the advancement of light emitting diodes (LEDs), a lighting fixture using LEDs is highly desirable since LEDs are solid state components, are robust, and are highly energy efficient. FIGS. 2A-2B illustrate a lighting fixture 10 that uses LEDs. The lighting fixture 10 may be a conventional lighting fixture that has been adapted to use LEDs. Alternatively, the lighting fixture 10 may be specifically designed to use LEDs.

As shown in FIGS. 2A-2B, the lighting fixture 10 has three LED light modules 12, 14, and 16 received in central channel 18 and electrically connected to a power source (not shown) such as an LED driver. It should be understood that the lighting fixture 10 is not limited to three LED modules and that any number of LED modules may be used to achieve adequate lighting and/or a specific aesthetic design. Also, the LED modules are not limited to certain sizes or shapes.

As illustrated in FIGS. 2A-2B, the lighting fixture 10 is shown using three rectangular-shaped LED modules 12, 14, and 16 where two of the LED modules 12 and 16 face downward and one LED module 14 faces upward. Alternatively, all the three LED modules 12, 14, and 16 may face either downward or upward, or two LED modules may face upward and one LED module may face downward. In the lighting fixture, where the LED modules are replacing T-5 fluorescent tubes, each LED module may have sufficient length, width, and depth to occupy a space that can accommodate a T-5 fluorescent tube.

As shown in FIG. 2B, each LED module 12, 14, and 16 may have an end cap 22, 24, and 26 at either end of the LED module 12, 14, and 16. The end cap 22, 24, and 26 includes a mounting flange 32, 34, and 36 that allows the LED module 12, 14, and 16 to be mounted onto the lighting fixture 10 using a screw or a rivet, for example. The mounting flange 32, 34, and 36 may be formed on the respective end cap 22, 24, and 26 at a central region thereof such that the mounting flange 32, 34, and 36 surface remains on a similar plane and aligns with the other mounting flange 32, 34, and 36 surfaces regardless of whether the LED module 12, 14, and 16 faces upward or downward from the lighting fixture 10. Each end cap 22, 24, and 26 may include an opening 42, 44, and 46 that allows access to a connectors 52, 54, and 56 that allows an LED driver to be connected with a light source array containing one or more LED packages 84.

Lighting fixture 10 may include an indicator 31 which may be a group of red, yellow, and green LEDs or a single LED package capable of producing red, yellow, and green light. The indicator 31 on the light fixture 10 can allow an occupant to know that the light fixture 10 is shedding light due to control signals from a wireless sensor. For example, a yellow light may emit from the indicator 31 to make such an indication. If a red light emits from the indicator 31, this indicates to the occupant that the light fixture is shedding light due to high electricity price at that moment in time. If the indicator 31 emits a green light, this indicates to the occupant that no light shedding is taking place.

The light source array will be described further below. Although not shown in FIGS. 2A-2B, the lighting fixture 10 includes one or more LED drivers, for example, at a side channel 11 to power one or more one or more LED modules.

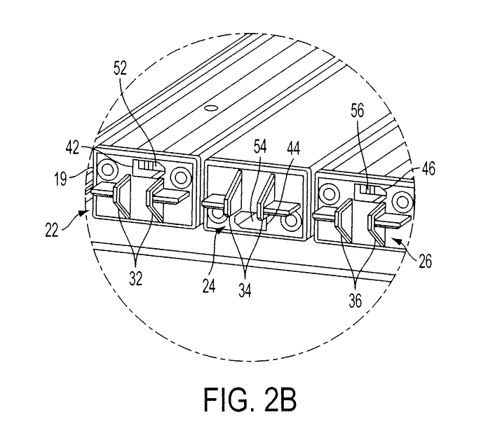

FIGS. 3A-3C illustrate a rectangular-shaped LED module 12 that includes a heat sink 60. The sides of the heat sink 60 may be covered a sheet 61, for example, a metal sheet, which forms a body of the LED module 12. The heat sink 60 also contains one or more light source arrays 62. For instance, the light source array 62 may be a continuous single circuit board shaped to fit into a cavity formed by three sides of the heat sink 60. Alternatively, the light source array 62 may be two or more circuit boards connected by connectors 58, 59 as shown in FIG. 3C. The connectors may be hermaphrodite connectors or one circuit board may have a male connector that connects to a female connector of another circuit board. While the circuit boards may be custom made to fit a specific sized LED module, it is usually formed of a unitary size where multiples of the unitary sized circuit boards connected together create an integrated circuit board meeting sizes set by industry standards. For example, the industry standard set for lighting fixture lengths may be 4 foot, 8 foot, 12 foot, and 16 foot. In this instance, the unitary size of the circuit board will be 4 foot with one or more circuit boards connected together by connectors as needed to meet a required length of the lighting fixture.

Heat sink 60 of LED module 12 may be used as a heat transfer mechanism for the heat generated by the LED packages 84 coupled to the light source array 62. For example, the heat sink 60 may be formed with aluminum or other materials having good heat transfer properties. The light source array 62, in turn, may be disposed on base portion 63 of heat sink 60. Thus, when the LED packages 84 are operational, heat generated by the LED packages 84 are transferred to the heat sink 60 via the light source array 62, which then is dissipated by the surrounding air.

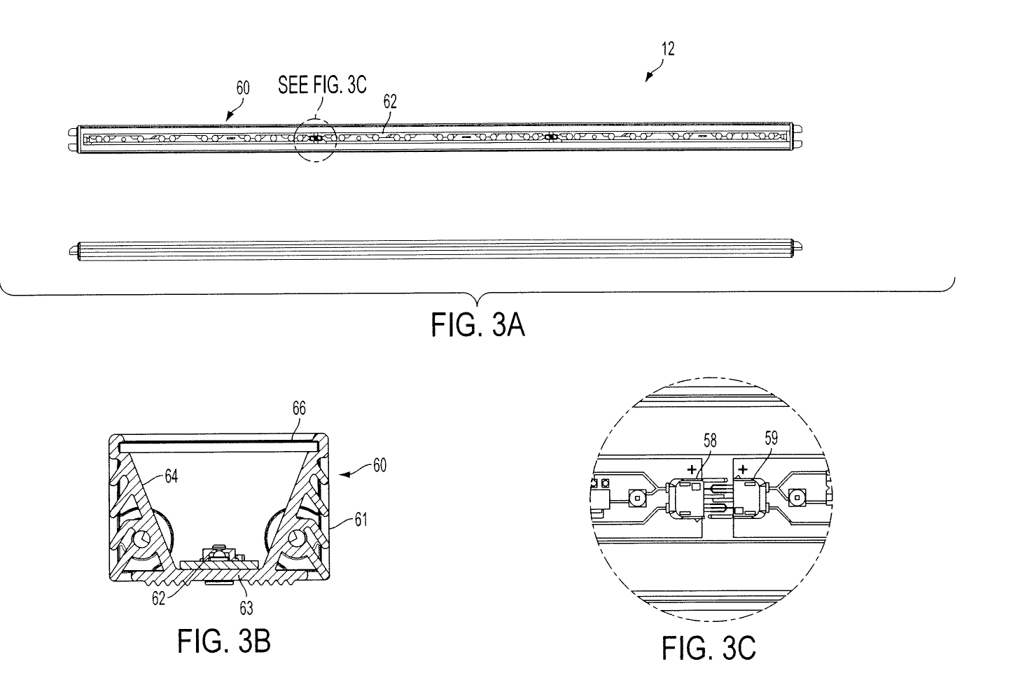

As illustrated in FIG. 4, heat transfer fins 65 may be provided to further increase the available heat transfer surface area, thus enhancing the heat removal efficiency of the system. Further, heat transfer ribs 68 may be disposed along a lower surface of heat sink 60 to create a space between the lower surface and a supporting surface such that the module 12, 14, and 16 may be placed at a bottom of channel 18 (see FIGS. 2A-2B).

The interior surface of the heat sink 60 body may be angled such that the sides radiate outward towards the outer edges of the heat sink 60 forming an optical surface 64. The optical surface 64 may be coated with a highly reflective film, such as an aluminum coating, to reflect light outwardly from the light source array 62. Alternatively, the optical surface 64 may be coated with a diffusing material such as white paint to diffuse light hitting the optical surface 64. Placement of any reflective substance on optical surface 64 would be sufficient as long as it reflects and diffuses the light produced by LED packages 84.

Heat sink 60 may include a cover covering a top of the heat sink 60 and that slides into slots 69. The cover may be lens 66 (see FIG. 3B) which is made of acrylic material with embedded diffusing crystals to diffuse light passing through the lens 66. The lens 66 may be transparent and/or semi-opaque. The lens 66 need not necessarily be made of acrylic material and any material may be used that is capable of diffusing light.

A mounting aperture 67 may be incorporated in the heat sink design. The mounting aperture 67 is adapted to span the length of the heat sink 60 and receive mounting screws 19 therein to couple end caps 22, 24, and 26 thereto (see FIGS. 2A-B). The end caps 22, 24, and 26 are coupled to heat sink 60 after lens 66 is inserted into slots 69 and light source array 62 are installed. Once the end caps 22, 24, and 26 are coupled to heat sink 60 the module 12, 14, and 16 may be transported as a single unit. It is envisioned that mounting screws 19 may be self-tapping screws that create their threads as they are screwed through an aperture in end caps 22, 24, and 26 and into mounting aperture 67. Mounting screws 19 may be replaced with other fixing means, such as rivets, bolts, welding, etc. A snap-fit geometric configuration between the end cap 22, 24, and 26 and the heat sink 60 may also be utilized, which would not require a separate fixing means.

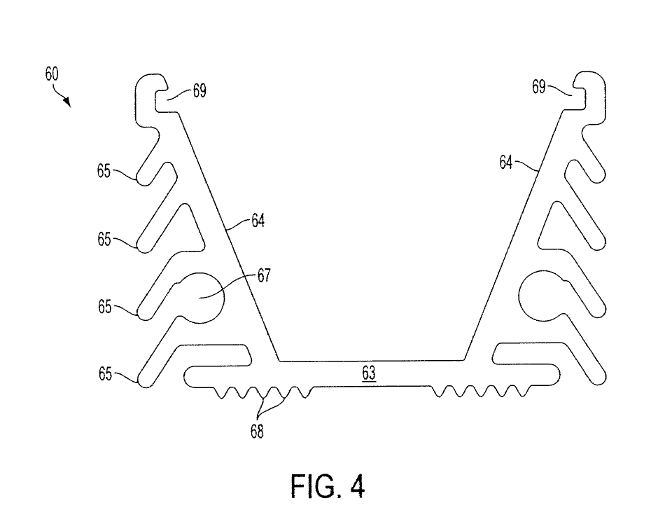

Referring now to FIGS. 5A-5B, cross-sectional views of the LED heat sink body 60 are shown. In an embodiment, a lenticular lens 76 is used having curved lenticular optics 77 (See FIG. 5B) is formed at an upper surface of the lens 76. The lenticular lens 76 provides for a wide beam distribution of light that is received directly from the light source array 62 or reflected from the optical surface 64.

One aspect of the light source array 62 is that it is formed with a plurality of discrete LED packages 84 and thus, bright spots may be formed at the LED module where the LED packages 84 are located. The lenticular lens 76 thus provided may allow for the dispersion of the bright spots and thereby form a more even light distribution along the light emitting surface 64 of the heat sink 60. While the heat sink body has been described with reference to lenticular lens 76, other lens arrays may be used. For instance, dome-shaped, convex, corrugated, or other known lens arrays may be used to achieve a desired result.

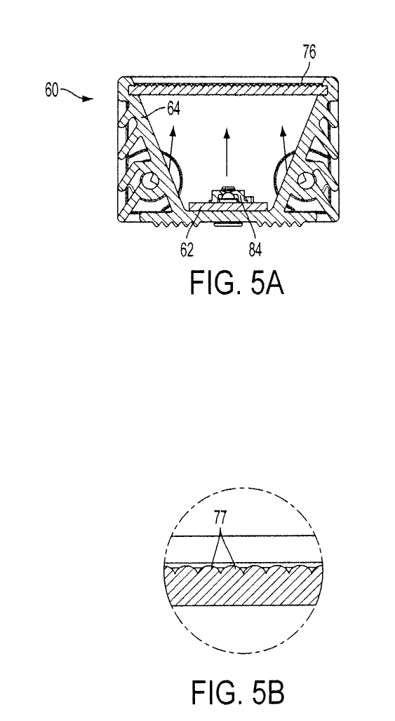

FIGS. 6A-6B illustrate a light source array 80 that includes a single or double-side printed circuit board (PCB) 82 for mounting a plurality of LED packages 84. While the PCB 82 may use a flexible material, the PCB 82 shown in FIGS. 6A-6B uses an aluminum core providing for a rigid PCB. The aluminum core also acts to draw heat away from the LED packages 84 to transfer the heat to heat sink 60, thus dissipating the heat to the surrounding area. A plurality of LED packages 84 may be evenly distributed on the PCB 82 or the plurality of LED packages 84 may be placed at locations of the PCB 82 that provides for a desired lighting distribution of the light source array.

Preferably three PCBs 82 may be coupled together to span the length of the LED light source array 62 (See FIGS. 3A-3C), to match the standard length of the T-5 fluorescent tube discussed above. Incorporating this standard length in the construction of light fixture 10 may allow the user the option of interchangeability between the T-5 fluorescent tube and LED modules 12, 14, and 16.

The LED packages 84 may be electrically connected in parallel. In FIGS. 6A-6B, however, the LED packages 84 are connected in series thereby simplifying the wiring of the LED packages 84, increasing reliability, and easing the manufacturing process. The PCB 82 shown in FIGS. 6A-6B is configured to connect with other PCBs 82 at both ends of the PCBs 82. Accordingly, the PCB 82 may include a hermaphrodite connector 83 at its both ends. Alternatively, a male connector may be used at one end and a female connector may be used at the other end.

One aspect of the LED packages connected in series is that when one LED package fails, the remaining LED packages at the PCB, and perhaps, including those LED packages in the other PCBs that are connected to this PCB can become inoperative. This may render the entire LED module inoperative. Various methodologies may be used to solve this problem as further described below.

For example, referring now to FIG. 6B which shows an end portion of the PCB 82, a thyristor 85 can be connected in parallel to the LED package 84. In the PCB 82 shown in FIGS. 6A-6B, there may be a one-to-one correspondence between the thyristor 85 and the LED package 84. However, this one-to-one correspondence is not compulsory and other designs may be used. In the event an LED package 84 fails, its corresponding thyristor 85 is activated, allowing current to flow through the thyristor 85, and thereby maintaining circuit connection. While a thyristor 85 has been used in FIGS. 6A-6B, other semiconductor devices may be used that achieve similar results, such as maintaining the circuit connection.

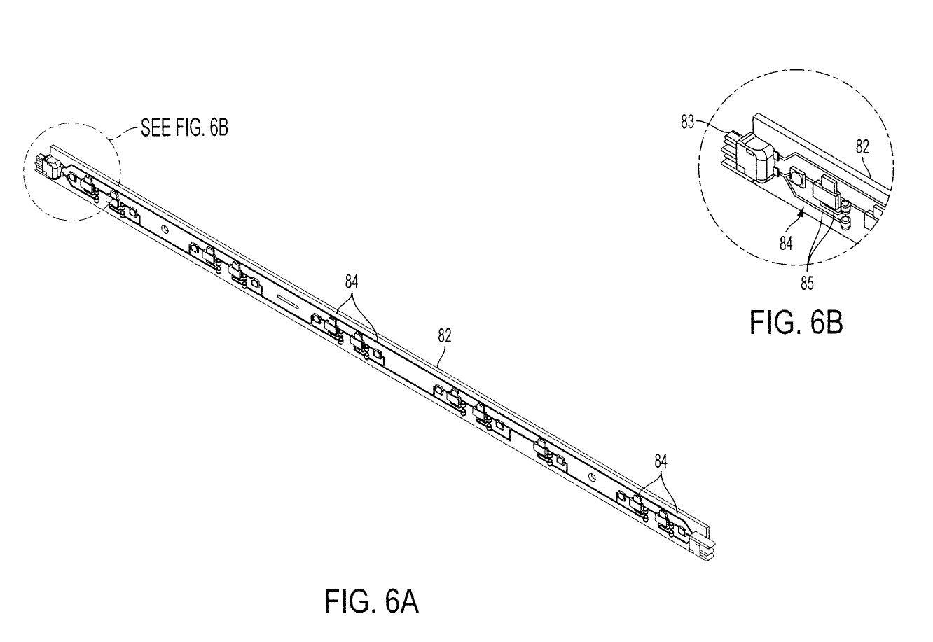

Referring now to FIG. 7, an end link PCB is shown and therefore, does not require connectors at its both ends. As further shown, one end of the PCB 90 is terminated with a zero ohm resistor 89 that is used as an end loop. This provides for a closed circuit in the series connection. While the PCB 90 shown in FIG. 7 uses a zero ohm resistor 89, alternatively, a closed end wiring may be printed at the PCB to eliminate the zero ohm resistor.

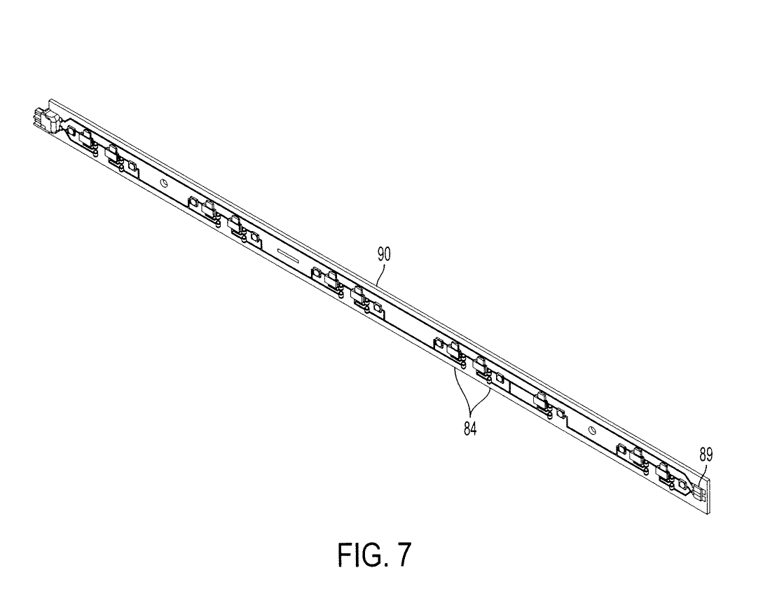

FIGS. 8A-8B illustrate a light fixture 100, similar to the light fixture 10 illustrated in FIG. 1 and substantially the same or similar elements will not be further described here. Light fixture 100 may receive three light modules 12, 14, and 102 in central channel 108. Light modules 12 and 14, as described above, have a rectangular cross-section and incorporate one level of LED packages 84 (See FIGS. 3A-3C). Light module 102 illustrates an alternative embodiment of the light module having a contoured outer surface 104 and two stacked levels of LED packages 84. Given the illustrated configuration, light module 102 is capable of casting light in both the upward and downward directions.

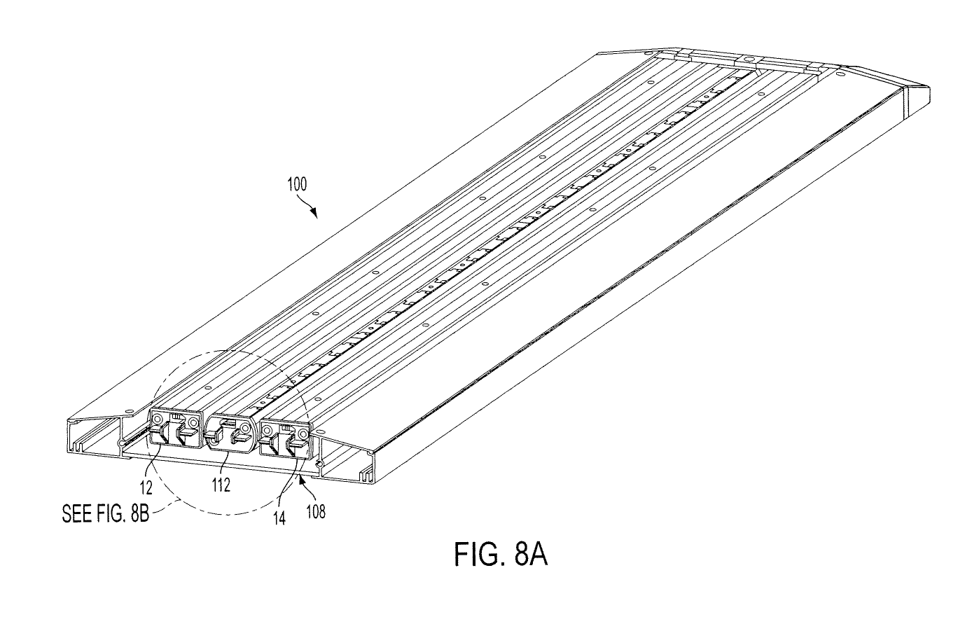

As shown in FIGS. 9A-9B, light module 102 may contain one or more light source arrays 162 having LED packages 184 disposed along one or more PCBs 180. The PCBs 180 are similar to the PCB 82 described above, therefore discussion of similar elements will be omitted.

Two separate PCBs 180 may be incorporated into light module 102, such that each PCB 180 has LED packages 184 disposed on one side thereof. Here the PCBs 180 would be stacked on top of each other and facing in opposite directions so that the light beam generated by the LED packages 184 is cast upwardly and downwardly.

LED heat sink 160 may be provided to house and support LED packages 184 on two separate PCBs 180. The use of two separate boards permits the separation of stacked board such that a heat transfer chamber 190 is provided therebetween. Chamber 190 provides a channel through which air may circulate to transfer heat created during operation of the LED packages 184 away from the interior surfaces of chamber 190. Such efficient transfer and dissipation of heat acts to prevent any loss or damage that might result from overheating of the LED packages 184. Accordingly, more LED packages can be provided in the same space of LED module 102 since the heat transfer can occur more efficiently.

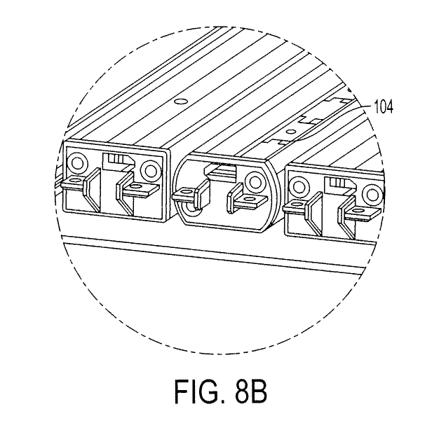

As shown in FIGS. 9A-9B and FIG. 10, heat sink 160 includes further design features to handle the removal of the heat generated during the operation LED packages 184. Heat sink 160 includes two substantially identical body portions 160A and 160B. The body portions 160A and 160B fit together such that a protrusion 170 of one body portion mates with channel 172. Connecting portion 168 acts to span the bridge between both sides of the body portions 160A and 160B and to provide a mounting surface for PCBs 180. Heat transfer fins 164 extend outwardly from a central region of body portion 160A and 160B and act to increase the surface area available for heat transfer.

With continued reference to FIG. 10, mounting portion 165 also extends outwardly from a central region of body portions 160A and 160B and includes mounting aperture 167. The mounting aperture 167 is adapted to span the length of the heat sink 160 and to receive mounting screws 19 as discussed above with respect mounting aperture 67 of heat sink 60. Accordingly, since mounting aperture 167 is similar to mounting 67 a description of similar elements will be omitted.

All surfaces of the heat sink 160 cooperate to increase the exposed surface area and thus enhance the heat transfer capabilities of the device. Heat sink 160 is preferably constructed of a material having high heat transfer properties, e.g. aluminum, to enable efficient heat removal and dissipation during operation of the light fixture 10. It is further envisioned that fans or similar devices may be employed to stimulate air circulation, thus further enhancing the heat transfer properties of the device.

Heat sink body portions 160 A and 160B can further include an angled optical surface 169 which may be coated with a high reflectivity film, similarly to optical surface 64 described above. Optical surface 169 acts to reflect and diffuse the light generated by LED packages 184. A cover may span the length of light module 102 and may be placed within slots 174. The cover may be lens 166. Accordingly, when body portions 160A and 160B are mated together to form module body 160, a lens would be disposed on both sides of module 102 such that light is cast in a predetermined pattern above and below the module 102. A lenticular lens, as described above, may also be used with module 102 in order to properly diffuse the generated light and eliminate bright spots that may be created due to the proximity of LED packages 184 to lens 166. Other lenses described above may also be used to diffuse or diffract light.

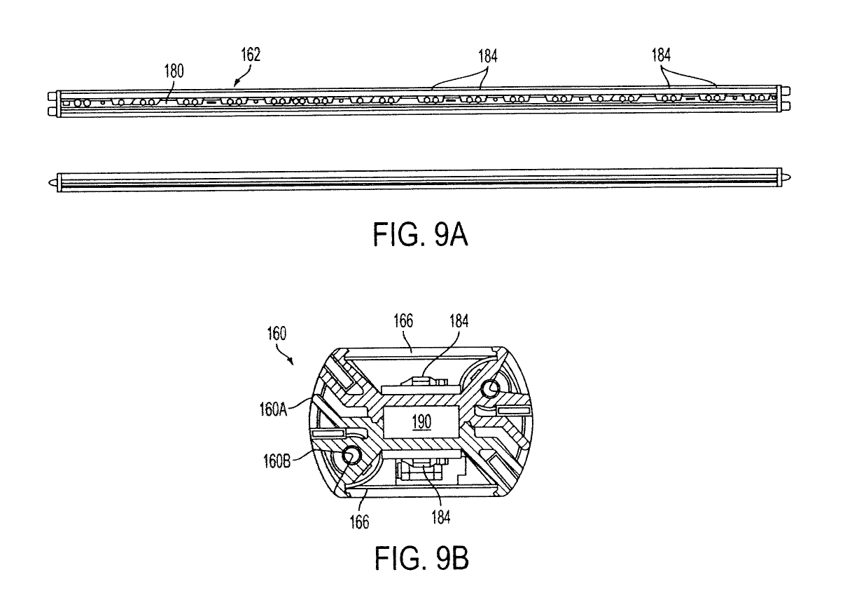

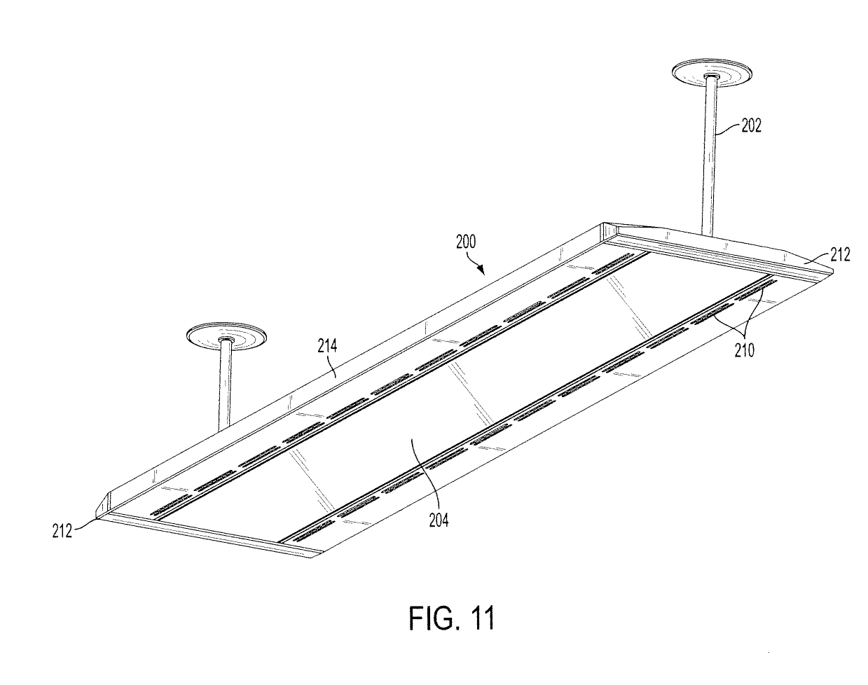

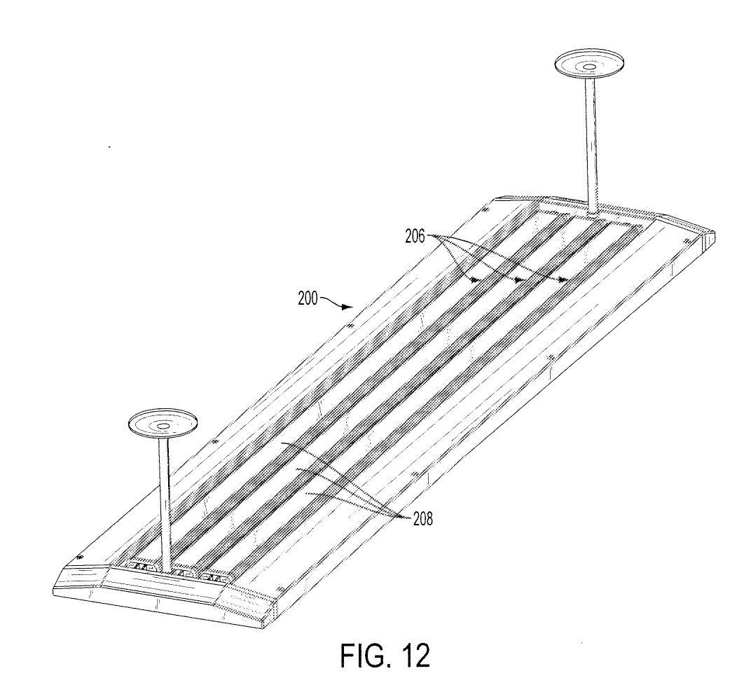

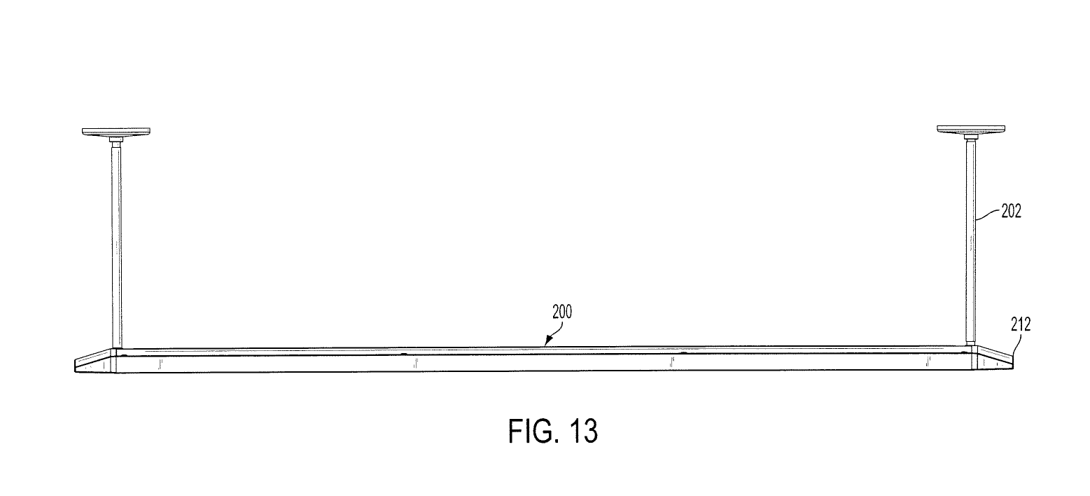

The structure of the light fixture and interchangeability of multiple light fixtures will be now be discussed below. As illustrated in FIGS. 11-15, a light fixture 200 may be attached to the ceiling of a room via posts 202. Posts 202 may be replaced with any type of hanging device known in the art such as wires, aircraft cables, chains, brackets. Further light fixture 100 may be attached directly to the ceiling, circumventing the need for a hanging device.

As illustrated in FIG. 11, a transparent panel 204 may be provided to emit the light generated by the light modules downward. In this case the lenses 66 and 166 may not be necessary since transparent panel 204 may be capable of dissipating and transmitting the generated light. It is noted that transparent panel may also be eliminated and the individual modules may each employ only their own individual lenses, or the lenses may be used in conjunction with the transparent panel to achieve a desired appearance or light emitting effect.

Vents 210 may be disposed on either side of the transparent panel 204 to aid in the evacuation of air and dissipation of heat. It is envisioned that vents may be placed in various locations along the exterior of light fixture 200 in a manner to further aid in air evacuation. Removable end caps may be coupled to a side end of main body 214.

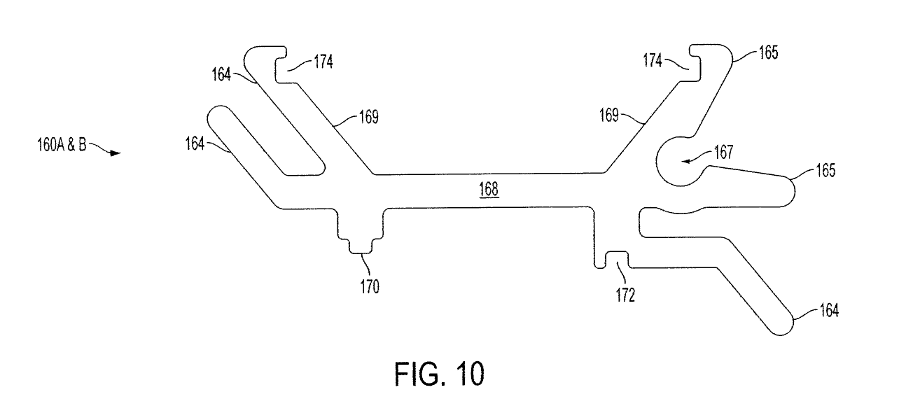

As illustrated in FIG. 12, light modules 206 having lenses 208 may be exposed at a top of light fixture 200 to cast light upward. As discussed above, various light modules may be employed in a variety of orientations, e.g., where one or two light modules face upward to cast light up, thus the configuration is not limited to that which is illustrated in FIG. 12. For example, a configuration similar to FIGS. 2A-2B or FIGS. 8A-8B may be incorporated in order to achieve a desired result. Further all light modules may be disposed to only cast light in one direction, e.g., only upward or only downward.

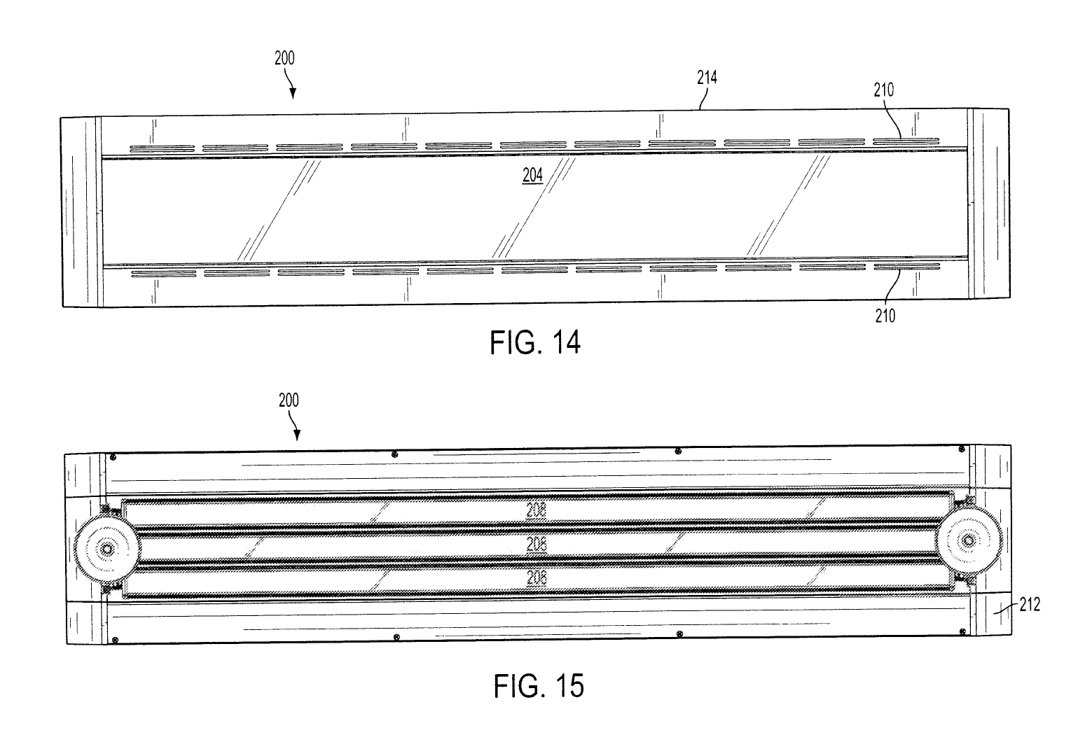

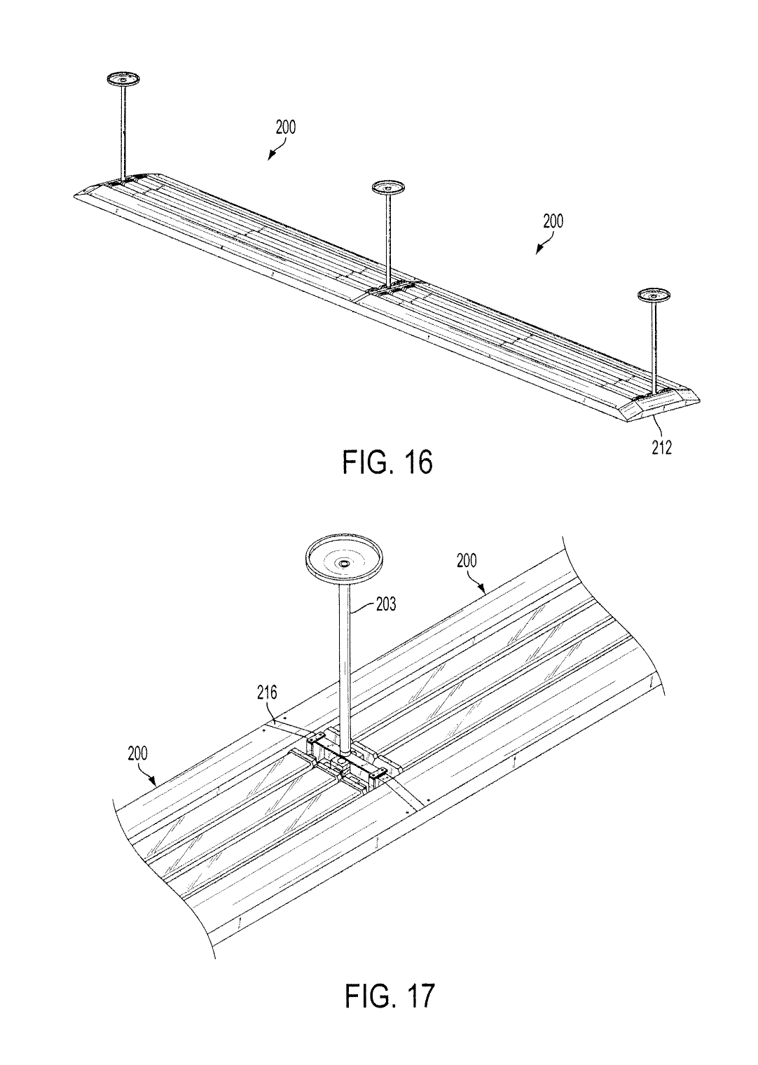

Referring now to FIGS. 16 and 17, multiple light fixtures 200 may be connected in series to create longer fixtures to accommodate the light requirements of larger rooms. In order to connect two or more light fixtures together, end caps 212 on respective sides of the light fixtures 200 are first removed such that a coupling may occur between exposed end portions. A coupling adapter 216 may be inserted between the two light fixtures 200 at the exposed end thereof to allow coupling. Posts 202 may be removed along with end cap 212 and a new post 203 may be disposed on the coupling adapter 216 to replace posts 202, as shown. Similarly coupling adapter 216 may not have a post 203 thereon, thus original posts 202 would not be removed with end caps 212, and thus would remain as the fixing member for attachment to a ceiling.

Where cables or the like are employed instead of posts 202, 203, various attachment points (not shown) may be disposed along an upper surface of light fixture 200 to accommodate necessary changes of location of the ceiling fixing member, e.g., the cables. The attachment points may take the form of hooks, brackets, or the like.

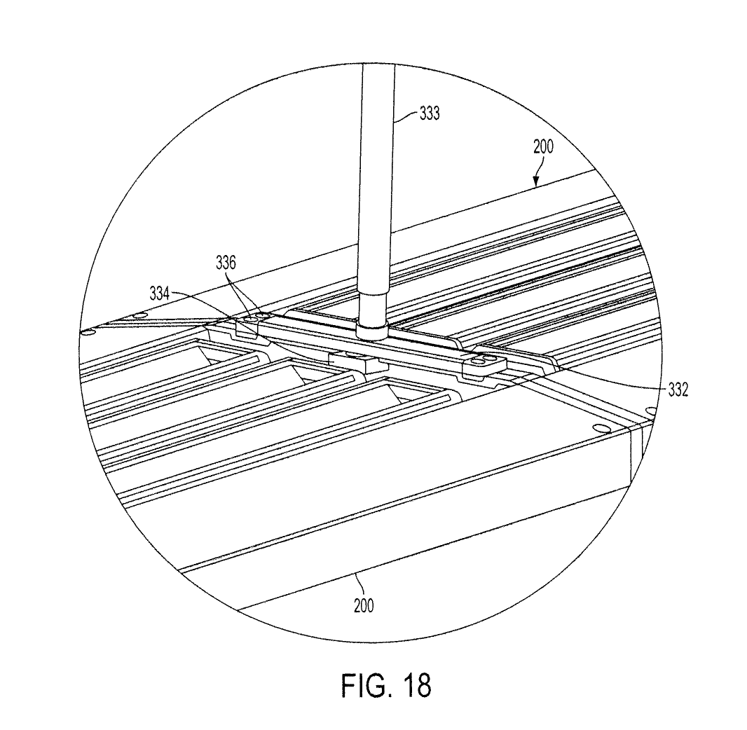

Referring to FIG. 18, another embodiment of the coupling method is disclosed. In the method of FIG. 18, the end caps 212 of two light fixtures 200 are removed. The end caps have mating geometry (not shown) which allows alignment and connection. Posts 202 are removed from mounting points 334 and coupling bracket 332 is attached between the light fixtures 200 to couple them together. Post 333 is placed on mounting bracket 332 to replace posts 202. Screws 336 are shown to fix bracket 332 to both light fixtures 200. It is noted that the mating geometry may also facilitate a locking engagement which may or may not need further support from bracket 332.

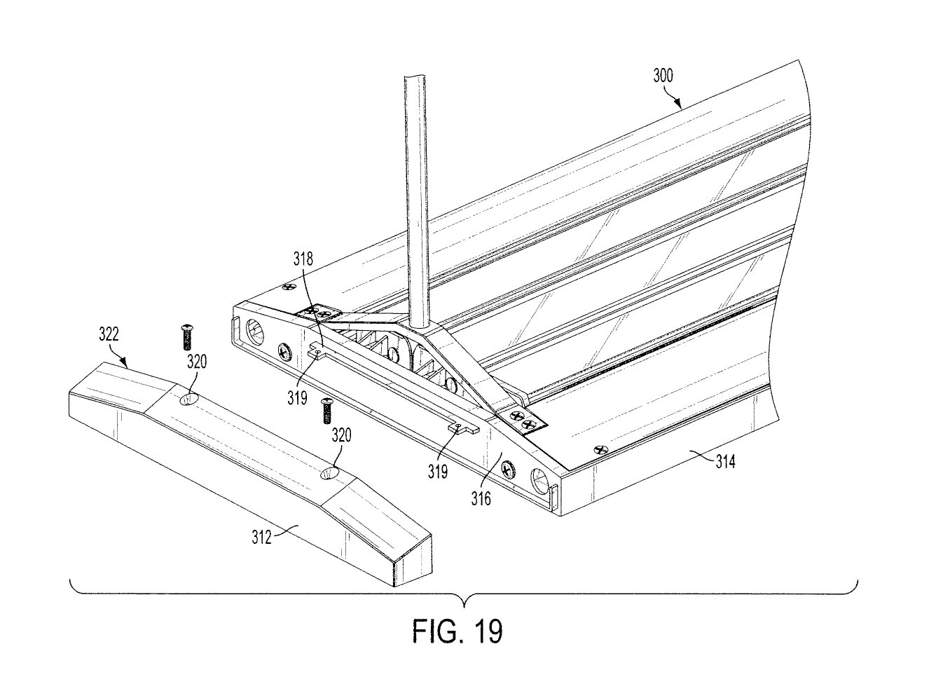

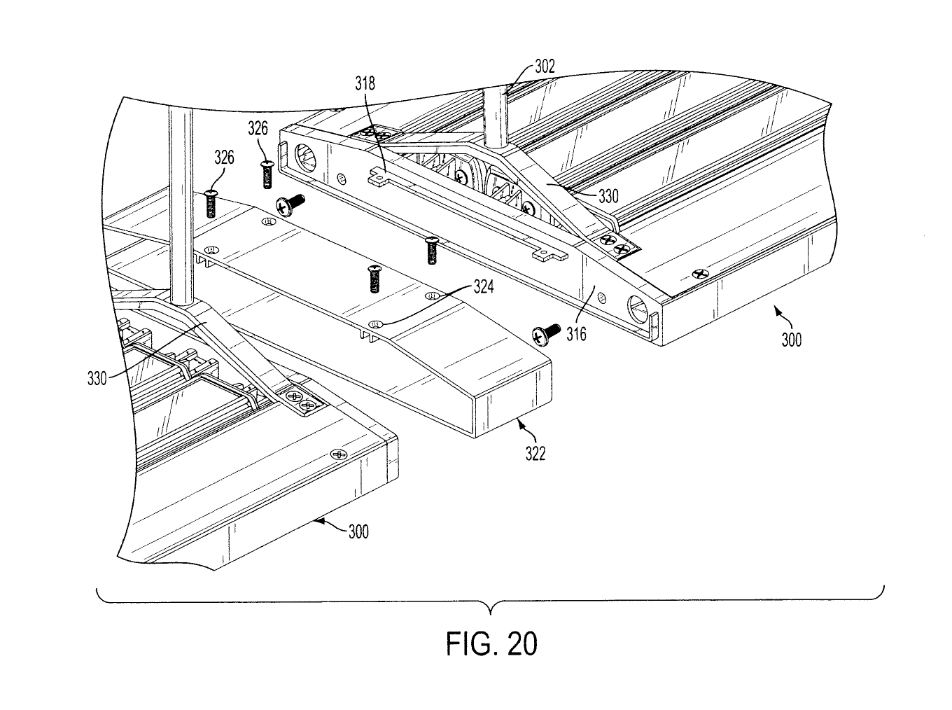

Now referring to the exploded views of FIGS. 19 and 20, another embodiment of the coupling method is disclosed. As illustrated in FIG. 19, end portions 316 of light fixture 300 have a connecting bracket 318 disposed thereon. The connecting bracket 318 has connecting apertures 319 which align with screw holes 320 to receive screws 322 therein to couple end cap 312 to main body 314.

As illustrated in FIGS. 19 and 20, end caps 312 may be removed to expose end portion 316 of main body 314. Once end portion 316 is exposed on both fixtures 300 which are to be coupled together, intermediate connector 322 having screw holes 324 is disposed therebetween. Connecting holes 319 of each respective bracket 318 for each light fixture 300 are then aligned with screw holes 324 of the respective sides of intermediate connector 322. Once all elements are aligned, screws 326 are screwed into holes 324 to couple the intermediate portion 322 to the light fixtures 300. Post brackets 330 are provided to connect posts 302 to light fixture 300.

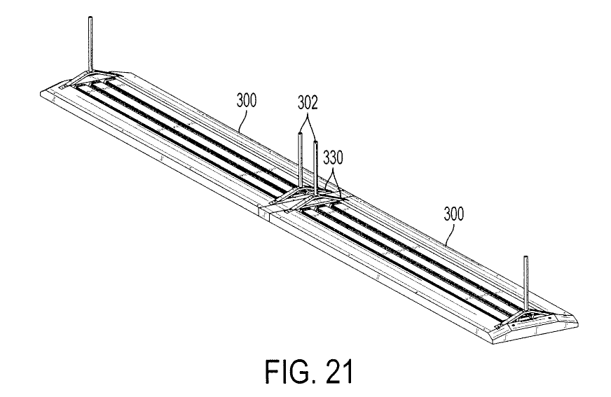

As viewed in FIG. 21, multiple light fixtures are connected to one another such that where the light fixtures connect with intermediate portion 322, two post brackets 330 and posts 302 are present. It is also envisioned that one or both of the post brackets 330 may be removed from the light fixtures 300. If both brackets 330 and posts 302 are removed when intermediate connector 322 is employed, intermediate connector 322 may have a post bracket 330 attached to an upper surface thereof. Thus when multiple light fixtures 300 are attached to one another, a single post may be centrally located between the fixtures 300, thus creating a more aesthetically pleasing appearance.

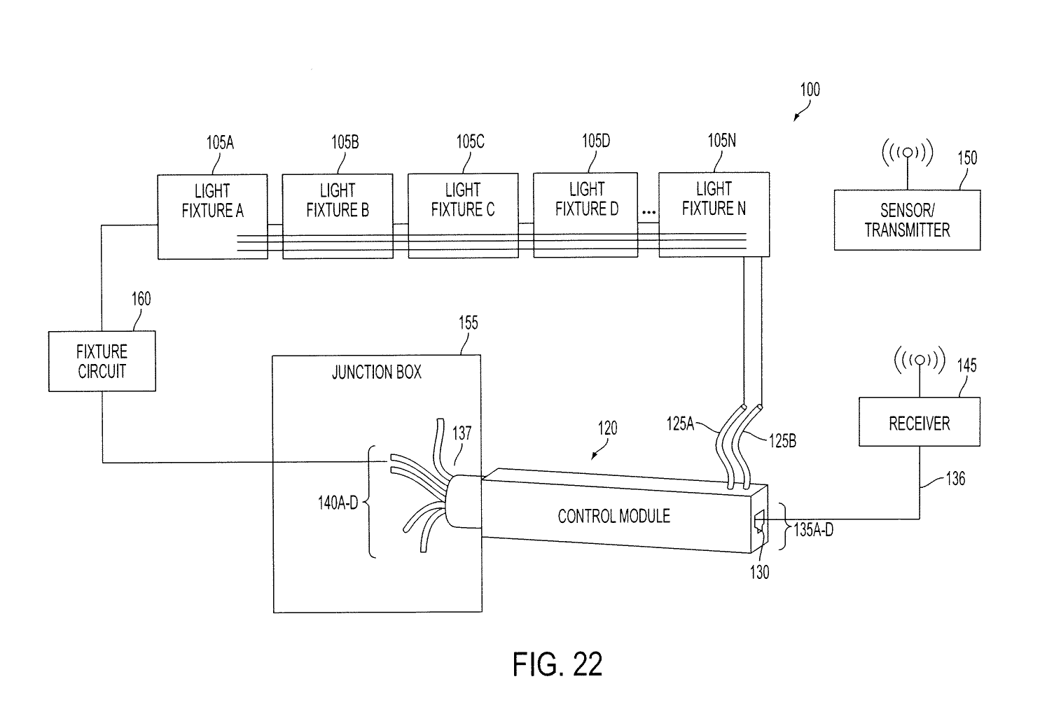

FIG. 22 illustrates an exemplary block diagram of a lighting system 100 capable of controlling and powering one or more light fixtures. As shown, a control module or device 120 communicates with a receiver 145, sensor 150, junction box 155, fixture circuit 160, and/or light fixtures 105A, 105B, 105C, 105D, and 105N (representative of any number of light fixtures) through a variety of connections. The junction box 155 can be any standard junction box existing along the power-supply “feeder” to the light fixtures 105A-N or added box by an electrician. The control module 120 draws power from the supply lines and can be wired to interrupt the flow of power to the light fixtures 105A-N—thus offering on-off control of the fixture. For certain fixtures full dimming is offered by 125A-B (as will be explained later). Light fixtures 105A-N could actually represent nearly any type of controllable load including but not limited to one or more LED drivers (not shown). Light fixtures 105A-N can include one or more LED drivers (not shown) and one or more LED modules (not shown). Communication within the system 100 may take place over one or more wires, wireless technologies, cables, or other digital or analog techniques, devices to perform these techniques, radio, a local area network (LAN), a wide area network (WAN), or the internet, for example. Of note, control module 120, receiver 145, or sensor 150 may reside on physically separate devices or be combined into the same device.

The junction box 155 may exist as part of a feeder circuit that feeds a string of light fixtures 105A-N or may be added along the conduit. For example, when a building is constructed an electrician may run the supply lines through the conduit and along that conduit may be one or more junction boxes. Into any one of these the electrician may wire up the control module 120 by powering the control module from the power that normally runs to a light fixture and then interrupting the flow downstream to light fixtures through the control module 120 so that the light fixtures can be controlled on and off via the control module 120. For example, an electrician may cut the black hot lead inside the junction box 155, and wire it up along with the white neutral to the control module 120.

Of note, although system 100 shows one receiver 145 and one sensor 150, the system 100 may include one or more receivers 145, one or more sensors 150, and one or more control modules 120. In an embodiment, another interface can be added to device 120 essentially “paralleling” the wires to the second 130 interface. This could exist external to the 120 device as a “Y-cable-adaptor” or simply as another interface on the control module 120 itself. For the second interface 130, lines 135A-D can run to a second “daisy-chained” control module in another fixture. Thus one receiver 145 can control multiple control modules. In another embodiment, one or more sensors 150 may transmit control or measurement signals to one or more receivers 145 associated with different lighting zones or areas in a room, building, or hallway, for example. The control or measurement signals transmitted by sensor 150 to receiver 145 can then be sent to control modules 120 which control light fixtures 105A-N associated with the different lighting zones using addressing via dip switches, for example. Based on the transmitted control or measurement signals, light fixtures 105A-N connected or controlled by a particular control module 120 can be individually controlled. In an exemplary embodiment, a series of motion sensor, receiver 145, and control module 120 triples may be used throughout a hallway to turn lighting fixtures 105A-N on and off as an individual progressively walks down the hallway. It should be noted that other configurations of sensors 150, receivers 145, and control modules 120 may also be used.

The receiver 145 can include a wireless interface to wirelessly communicate with one or more sensors 150 or nearly any compatible wireless device, such as a computer with a compatible wireless interface, wireless remote control, wireless wall switch, compatible wireless network, etc. Receiver 145 may be remotely mounted or positioned away from sensor 150 and may include a microcontroller. For example, receiver 145 can receive measurements and/or signals from the sensor 150 or a computer which can be used to operate or control light fixtures 105A-N. Based on the received signals or measurements, receiver 145 can provide control signals for light fixtures 105A-N to control module 120. In an embodiment, receiver 145 and control module 120 may be separate modules. For example, in some configurations of system 100, receiver 145 may be positioned outside light fixtures 105A-N and control module 120 may reside near or be entirely or partially housed within light fixtures 105A-N.

Sensor 150 can provide on/off and/or dimming controls signals for light fixtures 105A-N. The sensor 150 includes a wireless interface to wirelessly communicate with receiver 145. Various types of sensors 150 can be used in system 100, including motion, light harvest, timer, real-time-clock, remote-control, and the like. In some embodiments, sensor 150 may be positioned separately from receiver 145 because the measurements taken by sensor 150 can be improved by placing sensor away from light fixtures 105A-N and receiver 145. For example, in some embodiments when sensor 150 comprises a light harvesting sensor, light fixtures 105A-N can interfere with ambient light being measured by sensor 150. Thus, separating sensor 150 from receiver 145 can improve operation of system 100. In addition, splitting the functionality of system 100 across the control module 120, receiver 145, and sensor 150 can improve performance of system 100, allow for ease of installation, and reduce installation costs by minimizing wires, for example.

Control module 120 can be installed in a variety of configurations to provide power and controls to light fixtures 105A-N. For example, control module 120 may control one or more LED driver(s) which may be coupled to one or more LED modules. In addition, control module 120 may control other energy consuming devices (not shown), such as a motors, heaters, appliances, or other devices having on/off switches. Control module 120 may also be connected to junction box 155, which can advantageously allow fixture circuit 160 to control light fixtures 105A-N when they are strung together. In some embodiments, control module 120 may be connected or wired to junction box 155 directly or through other intermediaries, conduits, or circuits. Control module 120 may include one or more interfaces, such as such as primary interface 137, secondary interface 130, and dimming lines 125A-125B which provide various outputs and inputs as will be further described herein. These interfaces can be combined into the same interface or further divided into separate interfaces. Control module 120 may also include a power supply (not shown) to supply voltage to secondary interface 137, receiver 145, or other components of system 100.

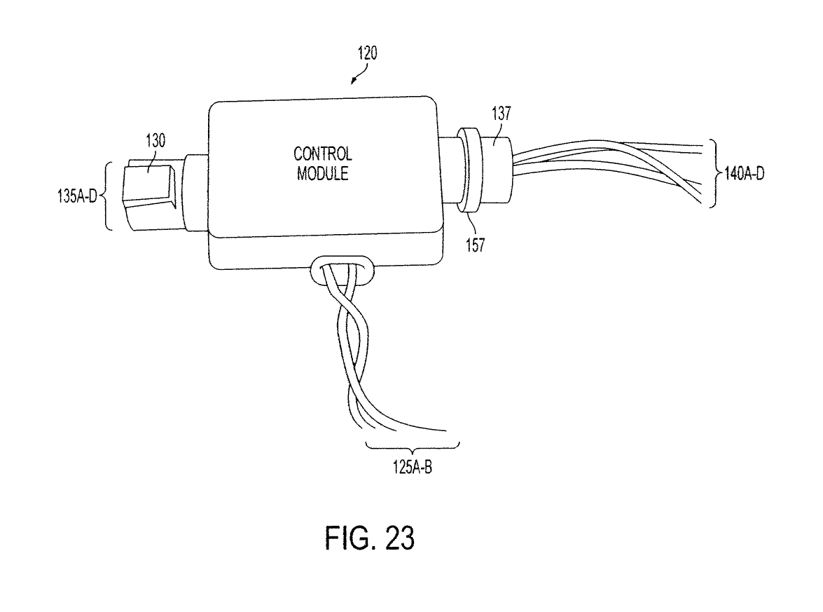

FIG. 23 illustrates an exemplary control module employed in the system of FIG. 22. In the illustrated embodiments, control module 120 may include dimming lines 125A-B for providing a dimming signal to control a LED driver (not shown) of light fixtures 105A-N. In exemplary embodiments, dimming lines 125A-B can be purple (or violet) and gray dimming lines and may be made from 18 American wire gauge (AWG) stranded wires. For example, purple dimming line 125A may provide a 0-10 Volt (V) dimming signal and gray dimming line 125B may provide a reference to ground. In addition, control module 120 can include a primary interface 137 which provides controls to light fixtures 105A-N, for example. Primary interface 137 may provide physical/electrical isolation and control of the primary power of light fixtures 105A-N or another load device, such as a motor, heater, or other energy consuming device. For example, primary interface 137 may be coupled to one or more LED drivers, to control power to light fixtures 105A-N.

It will be apparent to those skilled in the art that various modifications and variations can be made in the present disclosure without departing from the spirit or scope of the disclosure. Thus, it is intended that the present disclosure cover any modifications and variations within the scope of the appended claims and their equivalents.

What is claimed is:

1. A light fixture comprising:
a housing;
one or more light emitting diode (LED) modules provided in the housing, the LED modules including a heat sink and a light source array,
wherein the light source array is configured to fit into a cavity formed by three or more sides of the heat sink and the light source array includes a plurality of LED packages.

2. The light fixture of claim 1, wherein the light source array comprises a single circuit board.

3. The light fixture of claim 1, wherein the light source array comprises a plurality of circuit boards, the plurality of circuit boards connected by one or more connectors.

4. The light fixture of claim 1, wherein the light source array is disposed on a base portion of the heat sink.

5. The light fixture of claim 1, wherein an interior surface of the heat sink is angled and has sides radiating outward toward the outer edges to form an optical surface that reflects light outwardly from the light source array.

6. The light fixture of claim 1, further comprising a lenticular lens configured to cover a top portion of the heat sink.

7. The light fixture of claim 1, wherein the heat sink comprises a plurality of heat transfer ribs positioned on a lower surface of heat sink.

8. The light fixture of claim 1, further comprising a LED driver to power the one or more LED modules.

9. The light fixture of claim 8, further comprising an end cap provided on an end of each LED module, the end cap having an opening configured to allow the LED driver to be connected to power the one or more LED modules.

10. The light fixture of claim 1, further comprising a mounting aperture that is adapted to span a length of the heat sink and receive mounting screws to couple the mounting aperture to the heat sink.

11. A light emitting diode (LED) module comprising:
a heat sink; and
a light source array provided in a cavity formed by a plurality of sides of the heat sink, the light source array including a plurality of circuit boards, each of the circuit boards configured to receive a plurality of LED packages.

12. The LED module of claim 11, wherein the plurality of LED packages are evenly distributed on the circuit boards.

13. The LED module of claim 11, wherein the circuit boards are coupled together using one or more connectors.

14. The LED module of claim 11, wherein a length, width, and depth of the coupled circuit boards is substantially the same as a T-5 fluorescent tube.

15. The LED module of claim 11, wherein the plurality of circuit boards face opposite directions to cast light generated by the LED packages in both an upward and downward direction.

16. The LED module of claim 11, wherein at least two of the plurality of LED packages are stacked.

17. The LED module of claim 11, wherein the LED packages are connected in series to the plurality of circuit boards.

18. The LED module of claim 11, wherein the LED packages are connected in parallel to the plurality of circuit boards.

19. The LED module of claim 11, further comprising at least one thyristor connected in parallel with the plurality of LED packages to each of the circuit boards.

20. The LED module of claim 11, further comprising at least one semiconductor device connected in parallel with the plurality of LED packages to each of the circuit boards to maintain current flow through the circuit boards.
